(19) United States
(12) Patent Application Publication
(10) Pub. No.: US 2023/0212339 A1
(43) Pub. Date: Jul. 6, 2023

(54) VINYL ALCOHOL COPOLYMER, PRODUCTION METHOD THEREOF, ANTI-DEHYDRATING AGENT FOR CEMENT SLURRY, AND ANTI-DEHYDRATING METHOD FOR CEMENT SLURRY

(71) Applicant: KURARAY CO., LTD., Okayama (JP)

(72) Inventors: Ghebrehiwet Ghebremeskel, Houston, TX (US); Keisuke Morikawa, Houston, TX (US); Takuma Kaneshima, Houston, TX (US)

(73) Assignee: KURARAY CO., LTD., Okayama (JP)

(21) Appl. No.: 17/928,011

(22) PCT Filed: May 24, 2021
(86) PCT No.: PCT/JP2021/019636

§ 371 Date: Nov. 28, 2022

Related U.S. Application Data
(60) Provisional application No. 63/031,867, filed on May 29, 2020.

(51) Int. Cl. C08F 216/06; C08K 11/00

(52) U.S. Cl. CPC C08F 216/06; C08K 11/00

(57) ABSTRACT

A vinyl alcohol copolymer, wherein the vinyl alcohol copolymer includes a vinyl alcohol unit and a constituent unit derived from an unsaturated monomer (A), the unsaturated monomer (A) is at least one selected from the group consisting of an unsaturated carboxylic acid, a salt thereof, an anhydride thereof, and an alkyl ester thereof, a content of the constituent unit derived from the unsaturated monomer (A) with respect to total constituent units of the vinyl alcohol copolymer is 1.00 mol % or more and 5.00 mol % or less, and 70 mol % or more of the constituent unit derived from the unsaturated monomer (A) forms a lactone ring structure.

### TECHNICAL FIELD

The present disclosure relates to a vinyl alcohol copolymer, a production method thereof, an anti-dehydrating agent for a cement slurry, and an anti-dehydrating method for a cement slurry.

### BACKGROUND ART

Conventionally, in wells for extracting natural resource deposits such as petroleum and natural gas, a drilling cement slurry is known to be used. In well drilling, a gap (annulus) between a casing pipe and the well is filled with the drilling cement slurry, which is used for fixing the casing pipe. The cement slurry is injected through the casing pipe, then penetrates from the bottom of the well into the annulus, and is hardened. An inner wall of the well is protected by this step, which is referred to as “cementing”. A cement slurry suitable for such an operation has low viscosity, thereby enabling easy filling.

However, this method still involves a problem of dehydration, such as outflow of water contained in the cement slurry to porous geologic strata and/or rocks, due to contact of the pressurized cement slurry with a wall face of the well. When water in the cement slurry is lost by the dehydration, viscosity of the slurry increases, leading to a decrease in fluidity, which may result in unsatisfactory packing of the cement. In addition, the outflow of water to the geologic strata can lead to collapse of the geologic strata. Furthermore, alteration of a water/cement ratio in the cement slurry can lead to insufficient hardening of the cement.

In order to solve the problem, using a polyvinyl alcohol based resin as an anti-dehydrating agent, which is capable of reducing fluid loss, for a cement slurry has been known.

The anti-dehydrating agent for a cement slurry is required, in the cement slurry, to inhibit the dehydration by absorbing water in the slurry and swelling so as to reduce permeability of the wall of the well. On the other hand, there may be a case in which the anti-dehydrating agent for a cement slurry is preserved in the open air, and may get wet with rain during the operation; therefore, the anti-dehydrating agent is required have water resistance (being unlikely to dissolve in water) until the slurry is produced.

Patent Document 1 (U.S. Pat. No. 4,967,839) discloses a method in which a vinyl alcohol polymer having a degree of saponification of 92 mol % or less is used; however, this method involves a problem of needing care in handling so as not to be brought into contact with water during storage and use, due to the vinyl alcohol polymer having inferior water resistance.

Patent Document 2 (U.S. Pat. No. 4,569,395) discloses a method in which a vinyl alcohol polymer having a degree of saponification of 95 mol % or more is used; however, this method involves a problem of the effect as the anti-dehydrating agent for a cement slurry being sufficient, due to the vinyl alcohol polymer having a poor swelling property.

Patent Document 3 (U.S. Pat. No. 7,815,731) discloses a method in which two types of vinyl alcohol copolymers both having a degree of saponification of 97% or more but having degrees of polymerization that differ from each other are concomitantly used; however, this method assumes use at high temperatures of 195 degrees Fahrenheit (about 91° C.) or higher, and use at temperatures of about 140 degrees Fahrenheit (60° C.), which are more typical is not referred to.

Patent Document 4 (U.S. patent Ser. No. 10/550,038) discloses a method in which a crosslinked product of a modified polyvinyl alcohol based resin is used; however, performance as the anti-dehydrating agent for a cement slurry is not sufficient.

### PRIOR ART DOCUMENTS

### Patent Documents

Patent Document 1: U.S. Pat. No. 4,967,839
Patent Document 2: U.S. Pat. No. 4,569,395
Patent Document 3: U.S. Pat. No. 7,815,731
Patent Document 4: U.S. patent Ser. No. 10/550,038

### SUMMARY OF THE INVENTION

### Problems to be Solved by the Invention

An object of the present disclosure is to provide, for a cement slurry to be used in an intended usage such as well drilling, a vinyl alcohol copolymer which is superior in a capability of inhibiting dehydration and is superior in water resistance during storage and operation, as well as an anti-dehydrating agent for a cement slurry, the anti-dehydrating agent containing the vinyl alcohol copolymer. A further object of the present disclosure is to provide a production method for producing the vinyl alcohol copolymer, and an anti-dehydrating method for a cement slurry in which the anti-dehydrating agent for a cement slurry is used.

### Means for Solving the Problems

The present inventors elaborately investigated in order to solve the foregoing problems and consequently found that a vinyl alcohol copolymer including a particular constituent unit derived from an unsaturated monomer (A) can solve the aforementioned problems, and accomplished the present invention.

More specifically, the present disclosure is directed to a vinyl alcohol copolymer, wherein the vinyl alcohol copolymer includes a vinyl alcohol unit and a constituent unit derived from an unsaturated monomer (A), the unsaturated monomer (A) is at least one selected from the group consisting of an unsaturated carboxylic acid, a salt thereof, an anhydride thereof, and an alkyl ester thereof, a content of the constituent unit derived from the unsaturated monomer (A) with respect to total constituent units of the vinyl alcohol copolymer is 1.00 mol % or more and 5.00 mol % or less, and 70 mol % or more of the constituent unit derived from the unsaturated monomer (A) forms a lactone ring structure.

The unsaturated monomer (A) is preferably at least one selected from the group consisting of methyl acrylate and methyl methacrylate.

A degree of saponification of the vinyl alcohol copolymer is preferably 95 mol % or more.

An average degree of polymerization of the vinyl alcohol copolymer is preferably 1,500 or more and 5,000 or less.

The vinyl alcohol copolymer is preferably a powder capable of passing through a 7.5 mesh sieve in accordance with JIS.

Moreover, the present disclosure is directed to a production method for producing the vinyl alcohol copolymer, the production method including steps of: copolymerizing a vinyl ester monomer and the unsaturated monomer (A) to obtain a vinyl ester copolymer; saponifying the vinyl ester copolymer to obtain a vinyl alcohol copolymer; and washing with a solution of a carboxylic acid in alcohol, the vinyl alcohol copolymer after the saponifying.

Furthermore, the present disclosure is directed to a production method for producing the vinyl alcohol copolymer, the production method including steps of: copolymerizing a vinyl ester monomer and the unsaturated monomer (A) to obtain a vinyl ester copolymer; and saponifying the vinyl ester copolymer in a slurry state to obtain a vinyl alcohol copolymer.

In addition, the present disclosure is directed to an anti-dehydrating agent for a cement slurry, the anti-dehydrating agent containing the vinyl alcohol copolymer.

Further, the present disclosure is directed to an anti-dehydrating method for a cement slurry, the anti-dehydrating method including mixing a cement, a liquid formulation, and the anti-dehydrating agent for a cement slurry.

### Effects of the Invention

The present disclosure enables providing, for a cement slurry to be used in an intended usage such as well drilling, a vinyl alcohol copolymer which is superior in a capability of inhibiting dehydration and is superior in water resistance during storage and operation, as well as an anti-dehydrating agent for a cement slurry, the anti-dehydrating agent containing the vinyl alcohol copolymer. Furthermore, the present disclosure enables providing, a production method for producing a vinyl alcohol copolymer, and an anti-dehydrating method for a cement slurry in which the anti-dehydrating agent for a cement slurry is used.

### DESCRIPTION OF EMBODIMENTS

Hereinafter, the present invention will be described in detail, but exemplary embodiments are merely demonstrated thereby, and the present invention should not be construed to be limited thereto.

### Vinyl Alcohol Copolymer

The vinyl alcohol copolymer according to the present disclosure includes a vinyl alcohol unit and a constituent unit derived from an unsaturated monomer (A), the unsaturated monomer (A) is at least one selected from the group consisting of an unsaturated carboxylic acid, a salt thereof, an anhydride thereof, and an alkyl ester thereof, a content of the constituent unit derived from the unsaturated monomer (A) with respect to total constituent units of the vinyl alcohol copolymer is 1.00 mol % or more and 5.00 mol % or less, and 70 mol % or more of the constituent unit derived from the unsaturated monomer (A) forms a lactone ring structure.

The unsaturated monomer (A) is at least one selected from the group consisting of an unsaturated carboxylic acid, a salt thereof, an anhydride thereof, and an alkyl ester thereof. The unsaturated monomer (A) are exemplified by unsaturated monomers that are copolymerizable with vinyl ester monomers, and examples of the unsaturated monomer include: unsaturated carboxylic acids such as maleic acid, itaconic acid, acrylic acid, and methacrylic acid; salts thereof (alkali salts, alkali metal salts, etc.); anhydrides thereof (maleic anhydrides, etc.), and alkyl esters thereof (methyl esters, ethyl esters, etc.); and the like. Of these, at least one of methyl acrylate and methyl methacrylate is preferred in light of an ability to increase a formation percentage of a ring structure, and methyl acrylate is more preferred in light of the production.

The content of the constituent unit derived from the unsaturated monomer (A) in the vinyl alcohol copolymer of the present disclosure, with respect to total constituent units of the vinyl alcohol copolymer, is 1.00 mol % or more and 5.00 mol % or less. When the content is less than 1.00 mol %, the swelling property in the cement slurry may be deteriorated, whereby an anti-dehydrating effect tends to be impaired. It is to be noted that, for example, even with a vinyl alcohol polymer having the content of the constituent unit derived from the unsaturated monomer (A) being less than 1.00 mol %, a sufficient anti-dehydrating effect can be achieved as long as the degree of saponification thereof is low; however, in this case, water resistance may be inferior. In light of further enhancing the anti-dehydrating effect, the lower limit of this content is preferably 1.20 mol %, and more preferably 1.50 mol %. On the other hand, when the content is more than 5.00 mol %, the anti-dehydrating effect tends to be inferior due to immediate dissolution in the cement slurry. In light of further enhancing the anti-dehydrating effect, and the like, the upper limit of this content is preferably 4.90 mol %, more preferably 4.50 mol %, still more preferably 4.00 mol %, yet more preferably 3.50 mol %, yet more preferably 3.00 mol %, and particularly preferably 2.50 mol %. The vinyl alcohol copolymer of the present disclosure may have one, or two or more types of the constituent unit derived from the unsaturated monomer (A). In the case in which two or more types of the constituent unit are included, a total of contents of these two or more types of the constituent unit preferably falls within the above range. It is to be noted that as referred to in the present disclosure, the constituent unit in the polymer means a repeating unit constituting the polymer. For example, the constituent unit may be the vinyl alcohol unit described below as well as a vinyl ester unit.

It is to be noted that the term “anti-dehydrating” in the “anti-dehydrating effect” and the like as referred to herein does not only mean that dehydration does not occur in any way, i.e., that the amount of dehydration is zero; rather, this term has a meaning which also includes the amount of dehydration being decreased. In other words, even in a case in which the dehydration occurs, the anti-dehydrating effect is considered to be achieved as long as the amount of dehydration decreases. Furthermore, the “dehydration” in a cement slurry, as referred to herein, means that water and other liquid formulation(s) in the cement slurry exit from the cement slurry.

Seventy mol % or more of the constituent unit derived from the unsaturated monomer (A) in the vinyl alcohol copolymer of the present disclosure forms a lactone ring structure. The proportion of forming of a lactone ring structure by the structural unit derived from the unsaturated monomer (A) is preferably 80 mol % or more, and more preferably 90 mol % or more. When such a proportion is less than 70 mol %, water resistance and the anti-dehydrating effect during storage and operation may be deteriorated. Moreover, the proportion of forming of the lactone ring structure by the structural unit derived from the unsaturated monomer (A) may be 100 mol % or less, may be 99 mol % or less, or may be 98 mol % or less. Furthermore, the proportion of forming of the lactone ring structure by the structural unit derived from the unsaturated monomer (A) is preferably 80 mol % or more and 99 mol % or less, and more preferably 90 mol % or more and 99 mol % or less. In addition, the lactone ring structure formed by the constituent unit derived from the unsaturated monomer (A) is preferably a lactone ring structure formed in the vinyl alcohol copolymer, from a carboxyl group included in the constituent unit derived from the unsaturated monomer (A), with an adjacent hydroxyl group, and the lactone ring structure is preferably a lactone ring structure having a 5-membered ring, and the lactone ring structure having a 5-membered ring is preferably formed in the aforementioned proportion.

In the constituent unit derived from the unsaturated monomer (A) in the vinyl alcohol copolymer of the present disclosure, a constituent unit not forming the lactone ring structure is preferably a constituent unit not post-modified, and for example, a constituent unit not having an amino group is preferred. More specifically, the constituent unit not forming the lactone ring structure in the constituent unit derived from the unsaturated monomer (A) is preferably a constituent unit represented by —CH₂—CR¹(COOR²)— (wherein R¹ represents a hydrogen atom or a methyl group; and R² represents a hydrogen atom, an alkali metal, or an alkyl group). The alkyl group represented by R² is preferably a methyl group.

The degree of saponification of the vinyl alcohol copolymer as determined by ¹H-NMR is preferably 95 mol % or more, more preferably 99 mol % or more, and still more preferably 99.5 mol % or more. Furthermore, the degree of saponification of the vinyl alcohol copolymer may be 100 mol % or less, or may be 99.99 mol % or less. When the degree of saponification falls within the above range, water resistance during storage and operation may be further superior, whereby the production tends to be further facilitated. In addition, when the degree of saponification is more than the lower limit described above, the anti-dehydrating effect tends to be enhanced.

The vinyl alcohol unit can be derived from the vinyl ester unit by hydrolysis or alcoholysis. Thus, depending on, e.g., conditions in converting from the vinyl ester unit into the vinyl alcohol unit, the vinyl ester unit may remain in the vinyl alcohol copolymer. Accordingly, the vinyl alcohol copolymer of the present disclosure may include the vinyl ester unit.

The vinyl ester unit is a constituent unit derived from the vinyl ester monomer, and examples of the vinyl ester monomer include vinyl acetate, vinyl formate, vinyl propionate, vinyl caprylate, vinyl versatate, and the like. Of these, vinyl acetate is preferred from an industrial perspective.

The vinyl alcohol copolymer of the present disclosure may further have a constituent unit other than the vinyl alcohol unit, the constituent unit derived from the unsaturated monomer (A), and the vinyl ester unit, as long as the effects of the present disclosure are achieved. The constituent unit is, for example, a structural constituent unit derived from an ethylenic unsaturated monomer which is copolymerizable with the unsaturated monomer (A) and the vinyl ester monomer. Examples of the ethylenic unsaturated monomer include: α-olefins such as ethylene, propylene, n-butene, and isobutylene; acrylamide derivatives such as acrylamide, N-methylacrylamide, N-ethylacrylamide, N,N-dimethylacrylamide, diacetoneacrylamide, acrylamidepropane sulfonic acid and salts thereof, acrylamidepropyldimethylamine and salts thereof or quaternary salts thereof, and N-methylolacrylamide and derivatives of the same; methacrylamide derivatives such as methacrylamide, N-methylmethacrylamide, N-ethylmethacrylamide, methacrylamidepropane sulfonic acid and salts thereof, methacrylamidepropyldimethylamine and salts thereof or quaternary salts thereof, and N-methylolmethacrylamide and derivatives of the same; vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, and stearyl vinyl ether; nitriles such as acrylonitrile and methacrylonitrile; vinyl halides such as vinyl chloride and vinyl fluoride; vinylidene halides such as vinylidene chloride and vinylidene fluoride; allyl compounds such as allyl acetate and allyl chloride; vinylsilyl compounds such as vinyltrimethoxysilane; oxyalkylene group-containing monomers such as polyoxyethylene (meth)acrylate, polyoxypropylene (meth)acrylate, polyoxyethyleneamide (meth)acrylate, polyoxypropyleneamide (meth)acrylate, polyoxyethylene (1-(meth)acrylamide-1,1-dimethylpropyl) ester, polyoxyethylene (meth)allyl ether, polyoxypropylene (meth)allyl ether, polyoxyethylenevinyl ether, and polyoxypropylenevinyl ether; isopropenyl acetate; and the like. A content of the constituent unit other than the vinyl alcohol unit, the constituent unit derived from the unsaturated monomer (A), and the vinyl ester unit is, with respect to total constituent units of the vinyl alcohol copolymer, preferably 10 mol % or less, more preferably 5 mol % or less, still more preferably 2 mol % or less, and even more preferably 0 mol %, i.e., not substantially including the constituent unit other than the vinyl alcohol unit, the constituent unit derived from the unsaturated monomer (A), and the vinyl ester unit.

The order of alignment of the vinyl alcohol unit, the constituent unit derived from the unsaturated monomer (A), and the other arbitrary constituent unit(s) in the vinyl alcohol copolymer of the present disclosure is not particularly limited, and may be any of random, block, alternate, or the like.

Viscosity of a 4% aqueous solution of the vinyl alcohol copolymer at 20° C. as determined in accordance with JIS K 6726: 1994 is preferably 17 mPa·s or more and 130 mPa·s or less, more preferably 20 mPa·s or more and 120 mPa·s or less, still more preferably 30 mPa·s or more and 110 mPa·s or less, and even more preferably 40 mPa·s or more and 100 mPa·s or less. When the viscosity of the 4% aqueous solution at 20° C. falls within the above range, water resistance and/or the anti-dehydrating effect during storage and operation may be further superior, and the production tends to be facilitated.

The average degree of polymerization of the vinyl alcohol copolymer is preferably 1,500 or more and 5,000 or less, more preferably 2,000 or more and 4,800 or less, and still more preferably 2,400 or more and 4,600 or less. Furthermore, the average degree of polymerization is preferably 1,500 or more, more preferably 2,000 or more, and still more preferably 2,400 or more. Also, the average degree of polymerization is preferably 5,000 or less, more preferably 4,800 or less, and still more preferably 4,600 or less. When the average degree of polymerization falls within the above range, water resistance and/or the anti-dehydrating effect during storage and operation may be further superior, and the production tends to be facilitated. It is to be noted that the average degree of polymerization of the vinyl alcohol copolymer of the present disclosure is an average degree of polymerization determined in accordance with JIS-K6726-1994.

The form of the vinyl alcohol copolymer is not particularly limited, and may be powder. The powder of the vinyl alcohol copolymer is preferably powder having a particle diameter capable of passing through a 7.5 mesh sieve in accordance with JIS, more preferably powder capable of passing through a 16 mesh sieve in accordance with JIS, and still more preferably powder capable of passing through a 42 mesh sieve in accordance with JIS. When the particle diameter of the powder falls within the above range, dispersibility in the cement slurry tends to be favorable.

The production method for producing a vinyl alcohol copolymer of the present disclosure is not particularly limited. For example, a method including: copolymerizing the vinyl ester monomer and the unsaturated monomer (A); and saponifying a vinyl ester copolymer thus obtained, i.e., carrying out hydrolysis or alcoholysis, to obtain a vinyl alcohol copolymer is convenient and preferably employed.

A polymerization system for copolymerizing the vinyl ester monomer and the unsaturated monomer (A) may involve any one of batchwise polymerization, semi-batchwise polymerization, continuous polymerization, semi-continuous polymerization, and the like, and as a polymerization procedure, a well-known process such as a bulk polymerization process, a solution polymerization process, a suspension polymerization process, or an emulsion polymerization process may be adopted. The bulk polymerization process or the solution polymerization process, in each of which polymerization is allowed to proceed in the absence of a solvent or in a solvent such as an alcohol, is preferred. In a case in which a vinyl ester copolymer having a high degree of polymerization is to be obtained, employing the emulsion polymerization process may be one option. The solvent for use in the solution polymerization process is not particularly limited and may be, for example, an alcohol. The alcohol which may be used as the solvent for the solution polymerization process may be, for example, a lower alcohol such as methanol, ethanol, or propanol. The amount of the solvent used in the polymerization system may be selected taking into consideration chain transfer of the solvent, depending on the average degree of polymerization of the vinyl alcohol polymer intended. For example, in the case in which the solvent is methanol, a weight ratio {=(solvent)/(total monomers)}, being a ratio of the solvent to total monomers contained in the polymerization system, falls within a range of preferably from 0.01 to 10, and more preferably from 0.05 to 3.

A polymerization initiator used in the copolymerization of the vinyl ester monomer and the unsaturated monomer (A) is not particularly limited and may be selected from well-known polymerization initiators such as, e.g., an azo type initiator, a peroxide type initiator, and a redox type initiator, depending on the polymerization procedure. Examples of the azo type initiator include 2,2′-azobisisobutyronitrile, 2,2′-azobis(2,4-dimethylvaleronitrile), and 2,2′-azobis(4-methoxy-2,4-dimethylvaleronitrile). Examples of the peroxide type initiator include: percarbonate-based compounds such as diisopropyl peroxydicarbonate, di-2-ethylhexyl peroxydicarbonate, and diethoxyethyl peroxydicarbonate; perester compounds such as t-butyl peroxyneodecanate and α-cumyl peroxyneodecanate; acetylcyclohexylsulfonyl peroxide; 2,4,4-trimethylpentyl 2-peroxyphenoxyacetate; and the like. As the polymerization initiator, potassium persufate, ammonium persulfate, hydrogen peroxide, or the like may be used in combination with the initiator described above. The redox type initiator is a polymerization initiator prepared by combining, for example, the peroxide type initiator with a reducing agent such as sodium bisulfite, sodium bicarbonate, tartaric acid, L-ascorbic acid, or Rongalit. Although the amount of the polymerization initiator used cannot be generally predetermined since the amount may vary depending on the polymerization catalyst, the amount may be selected depending on a polymerization rate. For example, in the case in which azobisisobutyronitrile or acetyl peroxide is used as the polymerization initiator, the amount with respect to the vinyl ester monomer is preferably 0.01 mol % or more and 0.2 mol % or less, and more preferably 0.02 mol % or more and 0.15 mol % or less. The polymerization temperature is not particularly limited, and may be around room temperature or higher and about 150° C. or lower, and is preferably 40° C. or higher and a boiling point of the solvent used or lower.

The copolymerization of the vinyl ester monomer and the unsaturated monomer (A) may be carried out in the presence of a chain transfer agent as long as the effects of the present disclosure can be achieved. Examples of the chain transfer agent include: aldehydes such as acetaldehyde and propionaldehyde; ketones such as acetone and methyl ethyl ketone; mercaptans such as 2-hydroxyethanethiol; phosphinic acid salts such as sodium phosphinate monohydrate; and the like. In particular, aldehydes and ketones may be suitably used. The amount of the chain transfer agent added to the polymerization system may be predetermined depending on the chain transfer coefficient of the chain transfer agent to be added, and the degree of polymerization of the vinyl alcohol copolymer intended, and the amount of the chain transfer agent with respect to 100 parts by mass of the vinyl ester monomer is preferably 0.1 parts by mass or more and 10 parts by mass or less.

Saponification of the vinyl ester copolymer is conducted in a state of the copolymer being dissolved in an alcohol or hydrous alcohol, for example. The alcohol which may be used in the saponification is, for example, a lower alcohol such as methanol or ethanol, and is preferably methanol. The alcohol which may be used in the saponification may contain, for example, a solvent such as acetone, methyl acetate, ethyl acetate, or benzene as long as a content thereof is 40% by weight or less thereof. A catalyst for use in the saponification is exemplified by an alkali metal hydroxide such as potassium hydroxide or sodium hydroxide, an alkali catalyst such as sodium methylate, and an acid catalyst such as a mineral acid. A temperature at which the saponification is conducted is not limited, and suitably falls within a range of 20° C. or higher and 60° C. or lower. In a case in which a gelatinous product emerges to deposit as the saponification proceeds, the product may be pulverized and then washed and dried to enable giving the vinyl alcohol copolymer. The saponification process is not limited to those described above, and any of well-known methods can be adopted.

In order to adjust the proportion of forming of the lactone ring structure by the structural unit derived from the unsaturated monomer (A) to fall within the above range, the vinyl alcohol copolymer after being subjected to the saponification is preferably washed with a solution of a carboxylic acid in alcohol. The concentration of carboxylic acid in the alcohol solution is preferably 0.002% or more and 0.3% or less, more preferably 0.005% or more and 0.2% or less, and still more preferably 0.01% or more and 0.2% or less. A percentage content (percentage of the solid content) of the vinyl alcohol copolymer in the solution of a carboxylic acid in alcohol for use in the washing step is preferably 50% or less, more preferably 40% or less, and still more preferably 30% or less. Examples of the carboxylic acid include formic acid, acetic acid, butyric acid, lactic acid, malic acid, citric acid, benzoic acid, phthalic acid, oxalic acid, malonic acid, succinic acid, and the like, and acetic acid is preferred. Examples of the alcohol include methanol, ethanol, propanol, isopropanol, butanol, and the like, and methanol is preferably used.

In the present disclosure, when the vinyl alcohol copolymer is in a powder form, a procedure for adjusting the particle diameter to fall within the above range is exemplified by: a process of grinding particles of the vinyl alcohol copolymer with a grinding machine; and a process (slurry saponification process) of conducting saponification of the vinyl ester copolymer in a slurry state in a large excess amount of an alcohol solution. Of these, the slurry saponification process is preferably employed since the powder of the vinyl alcohol copolymer having the particle diameter intended can be obtained, without need of the carrying out the grinding step.

As one embodiment of the production method for producing a vinyl alcohol copolymer, a production method including: a polymerizing step of copolymerizing a vinyl ester monomer and the unsaturated monomer (A) to obtain a vinyl ester copolymer; a saponifying step of saponifying the vinyl ester copolymer to obtain a vinyl alcohol copolymer; and a washing step of washing with a solution of a carboxylic acid in alcohol, the vinyl alcohol copolymer after the saponifying is preferred.

In addition, as an other embodiment of the production method for producing a vinyl alcohol copolymer, a production method including: a polymerizing step of copolymerizing a vinyl ester monomer and the unsaturated monomer (A) to obtain a vinyl ester copolymer; and a saponifying step of saponifying the vinyl ester copolymer in a slurry state to obtain a vinyl alcohol copolymer is preferred.

The vinyl alcohol copolymer of the present disclosure may be a mixture with various other types of additives, within a range not leading to impairment of the gist of the present disclosure. Examples of the additives include: polymerization regulators such as aldehydes, halogenated hydrocarbons, and mercaptans; polymerization inhibitors such as phenol compounds, sulfur compounds, and N-oxide compounds; pH adjusting agents; crosslinking agents; antiseptic agents; mildew-proofing agents; antiblocking agents; defoaming agents; compatibility accelerators; and the like.

### Anti-Dehydrating Agent for Cement Slurry

The anti-dehydrating agent for a cement slurry of the present disclosure contains the vinyl alcohol copolymer described above. The anti-dehydrating agent for a cement slurry of the present disclosure may be the vinyl alcohol copolymer described above. The dehydrating agent for a cement slurry of the present disclosure may contain other component(s) aside from the vinyl alcohol copolymer of the present disclosure. The other component(s) is/are exemplified by the various types of additives described above, and the like. The content of the vinyl alcohol copolymer of the present disclosure in the dehydrating agent for a cement slurry is preferably 50% by mass or more, more preferably 70% by mass or more, still more preferably 90% by mass or more, and even more preferably 95% by mass or more. The content of the vinyl alcohol copolymer of the present disclosure in the dehydrating agent for a cement slurry may be 100% by mass or less.

The form of the dehydrating agent for a cement slurry of the present disclosure is not particularly limited, and being the powder is preferred. A suitable mode (size, etc.) in the case in which the dehydrating agent for a cement slurry is the powder is similar to the mode described above, as in the case of the vinyl alcohol copolymer of the present disclosure being in the powder form.

The anti-dehydrating agent for a cement slurry is used after mixing with a cement slurry (a liquid formulation and a cement). In one preferred embodiment, the cement slurry contains a liquid formulation, a cement (curable powder), other additive component(s), and the anti-dehydrating agent for a cement slurry of the present disclosure.

The content of the anti-dehydrating agent for a cement slurry in the cement slurry is, with respect to 100 parts by weight of the cement (curable powder), preferably 0.1 parts by weight or more and 5 parts by weight or less, more preferably 0.2 parts by weight or more and 3 parts by weight or less, and still more preferably 0.3 parts by weight or more and 1.5 parts by weight or less. When the content of the anti-dehydrating agent for a cement slurry falls within the above range, the anti-dehydrating effect can be further superior and the viscosity of the cement slurry may be more favorable.

The liquid formulation is predetermined depending on the type of the cement (curable powder) and the like, and is exemplified by: water; a solvent; and a mixture of these, and water is preferred. The content of the liquid formulation in the cement slurry is, with respect to 100 parts by weight of the cement (curable powder), preferably 30 parts by weight or more and 60 parts by weight or less, more preferably 33 parts by weight or more and 55 parts by weight or less, and still more preferably 35 parts by weight or more and 50 parts by weight or less. Further, it is preferred that the liquid formulation is water, and that the content of water falls within the above range. When the content of the liquid formulation falls within the above range, strength of the cured matter can be more favorable, and the viscosity of the cement slurry can be more favorable.

The cement (curable powder) is exemplified by Portland cement, a mixed cement, an eco-cement, a special cement, and the like. In particular, in drilling applications, a geothermal-well cement, and an oil-well cement may be preferably employed. These cements are defined by American Petroleum Institute as classes A to H standards, and cements of classes G and H are preferred.

The other additive component which may be added to the cement slurry is exemplified by a dispersant, a retarder, an accelerator, a low-density additive, a high-density additive, a strength stabilizer, a washing agent, a defoaming agent, a crosslinking agent, a scale inhibitor, a water loss inhibitor, and the like. These additive components may be added as needed, taking into consideration the composition, and either one type or multiple types thereof may be used.

Thus, according to the present disclosure, by using the anti-dehydrating agent for a cement slurry as described above, a further superior anti-dehydrating effect can be achieved. The vinyl alcohol copolymer and the anti-dehydrating agent for a cement slurry of the present disclosure are capable of exerting a superior anti-dehydrating function by ring opening of the lactone ring in an alkaline cement slurry, in general. On the other hand, since ring opening of the lactone ring is unlikely to occur in commonly used water or the like, the vinyl alcohol copolymer and the dehydrating agent for a cement slurry of the present disclosure have comparatively low solubility in commonly used water or the like, and thus are capable of exhibiting superior water resistance during storage and operation.

### Anti-Dehydrating Method for Cement Slurry

The anti-dehydrating method for a cement slurry according to the present disclosure is a method which includes mixing a cement, a liquid formulation, and the anti-dehydrating agent for a cement slurry. The mixing of the cement, the liquid formulation, and the anti-dehydrating agent for a cement slurry may be conducted according to a common procedure, and for example, the anti-dehydrating agent for a cement slurry of the present disclosure may be added to and mixed with a cement slurry produced by mixing the liquid formulation, the cement, and as needed, the other additive component(s).

The anti-dehydrating agent for a cement slurry according to the present disclosure can be suitably used for a drilling cement slurry to be used in drilling porous geologic strata, rocks, and the like.

### EXAMPLES

Hereinafter, the present invention is specifically explained by way of Examples, but the present invention is not in any way limited thereto. It is to be noted that in Examples, “part(s)”, or “%” means on mass basis, unless otherwise specified particularly.

### Average Degree of Polymerization of Vinyl Alcohol Copolymer

The average degree of polymerization of the vinyl alcohol copolymer was determined in accordance with JIS-K6726-1994.

### Viscosity of 4% by Mass Aqueous Solution of Vinyl Alcohol Copolymer at 20° C.

The viscosity of a 4% by mass aqueous solution of the vinyl alcohol copolymer at 20° C. was measured by using the B-type viscometer BLII (manufactured by Toki Sangyo Co., Ltd) under a condition involving: a rotor speed of 60 rpm, and a temperature of 20° C.

### Degree of Saponification of Vinyl Alcohol Copolymer

The degree of saponification of the vinyl alcohol copolymer (mol %) was determined by ¹H-NMR.

### Content (Modification Amount) of Constituent Unit Derived From Unsaturated Monomer (A)

The content (mol %; modification amount) of the constituent unit derived from the unsaturated monomer (A) in the vinyl alcohol copolymer was determined by ¹H-NMR.

### Proportion (Cyclic Structure Formation Percentage) of Forming of Lactone Ring

Structure by Constituent Unit Derived from Unsaturated Monomer (A)

The proportion (mol %; ring structure formation percentage) of forming of a lactone ring structure by a constituent unit derived from the unsaturated monomer (A) was determined by ¹H-NMR.

### Example 1

(1) Into a reactor equipped with a stirrer, a reflux condenser, an argon inlet tube, an addition port for the unsaturated monomer (A) (comonomer), and an addition port for the polymerization initiator were charged 1,392 parts by mass of vinyl acetate, 0.97 parts by mass of methyl acrylate as a comonomer, and 208 parts by mass of methanol, and replacement with argon in the system was carried out for 30 min while argon was bubbled. Separately therefrom, as a successively added solution of the comonomer (hereinafter, referred to as “delay solution”), a methanol solution of methyl acrylate (concentration: 20% by mass) was prepared, and argon was bubbled thereinto for 30 min. Temperature elevation of the reactor was started, and when the internal temperature became 60° C., 0.5 parts by mass of 2,2′-azobisisobutyronitrile (AIBN) were added to initiate polymerization. While the polymerization reaction proceeded, the delay solution which had been prepared was added dropwise into the system, whereby the monomer composition (molar ratio of methyl acrylate to vinyl acetate) in the polymerization solution was maintained constant. After allowing for the polymerization at 60° C. for 3.3 hrs, the polymerization was terminated by cooling. When the polymerization was terminated, the conversion (rate of polymerization) was 30%. Subsequently, unreacted monomer was eliminated while methanol was added at intervals at 30° C. under a reduced pressure to give a methanol solution of polyvinyl acetate (concentration: 25%) into which methyl acrylate had been introduced.

(2) To a saponification ingredient liquid prepared so as to adjust the concentration to be 20% by adding methanol to the methanol solution of polyvinyl acetate, which was obtained in (1) above, into which methyl acrylate had been introduced, a methanol solution of sodium hydroxide was further added such that a molar ratio of sodium hydroxide to vinyl acetate unit in polyvinyl acetate, into which methyl acrylate had been introduced, became 0.04, and saponification was conducted at room temperature. Since a gelatinous matter of the vinyl alcohol copolymer was produced in about 20 min after adding the methanol solution of sodium hydroxide, the gelatinous matter was ground with a grinding machine. Furthermore, the methanol solution of sodium hydroxide was added such that a molar ratio of sodium hydroxide to the monomer unit in the vinyl alcohol copolymer became 0.02, and the saponification was allowed to proceed by leaving a resulting mixture to stand at 40° C. for 2 hrs. The product was immersed in a 0.01% acetic acid methanol solution for 1 hour such that a percentage of the solid content became 20% and washed, and thereafter dried at 70° C. for 12 hrs. The dried matter was ground with a grinding machine so as to enable passing through a 42 mesh sieve in accordance with JIS, whereby a vinyl alcohol copolymer (PVA-1) was obtained. With respect to PVA-1 thus obtained, polymerization and saponification conditions, the average degree of polymerization, the degree of saponification, the viscosity of a 4% aqueous solution at 20° C., the content (modification amount) of the constituent unit derived from the unsaturated monomer (A), and the proportion of forming of a lactone ring structure by the constituent unit derived from the unsaturated monomer (A) (ring structure formation percentage) are shown in Table 1 and Table 2.

Examples 2, 4 to 6, and Comparative Examples 1 and 2 Vinyl alcohol copolymers (PVA-2, and PVA-4 to 8) were obtained similarly to Example 1 except that various types of conditions such as: the amounts of vinyl acetate and methanol charged; the amount of AIBN added; the type and the amount of the unsaturated monomer (A) added; the conversion (rate of polymerization); the saponification condition; and the concentration of acetic acid in the methanol solution for the washing operation were changed as shown in Table 1 and Table 2. With respect to PVA-2, and PVA-4 to 8 obtained, the components used for the polymerization, the conversion (rate of polymerization), the saponification condition, the concentration of acetic acid in the methanol solution for the washing operation, the average degree of polymerization, the degree of saponification, the viscosity of a 4% aqueous solution at 20° C., the content (modification amount) of the constituent unit derived from the unsaturated monomer (A), and the proportion of forming of a lactone ring structure by the constituent unit derived from the unsaturated monomer (A) (ring structure formation percentage) are shown in Table 1 and Table 2.

### Example 3

(1) A methanol solution of polyvinyl acetate (concentration: 35%) into which methyl acrylate had been introduced was obtained by changing various types of conditions as shown in Table 1, such as: the amounts of vinyl acetate and methanol charged; the amount of AIBN added; and the type and the amount of the unsaturated monomer (A) added.

(2) Polyvinyl acetate, which was obtained in (1) above, into which methyl acrylate had been introduced, was used to prepare a 33% methanol solution, and this solution was added into a reaction chamber, and thereto was added a methanol solution of anhydrous sodium methylate such that a molar ratio of sodium methylate to the vinyl acetate unit in polyvinyl acetate into which methyl acrylate had been introduced became 0.008. The reaction chamber was heated while stirring the solution, and maintained at a boiling point to conduct the saponification reaction, whereby a slurry liquid was obtained. The slurry liquid thus obtained was removed from the reaction chamber, and immersed in a 0.010% acetic acid methanol solution for 1 hour such that a percentage of the solid content became 20%. After washing, the slurry liquid was transferred to a cooling/heating treatment step, and cooled to a temperature of lower than 50° C. Next, in a solid-liquid separation step, the slurry liquid was separated into a solution and a wet cake of the vinyl alcohol copolymer. Thereafter, only the wet cake was retrieved, and was subjected to a drying treatment, whereby a vinyl alcohol copolymer (PVA-3) being aggregates of particulate powder was obtained. PVA-3 was capable of passing through a 42 mesh sieve in accordance with JIS. With respect to PVA-3 thus obtained, the components used for the polymerization, the conversion (rate of polymerization), the saponification condition, the concentration of acetic acid in the methanol solution for the washing operation, the average degree of polymerization, the degree of saponification, the viscosity of a 4% aqueous solution at 20° C., the content (modification amount) of the constituent unit derived from the unsaturated monomer (A), and the proportion of forming of a lactone ring structure by the constituent unit derived from the unsaturated monomer (A) (ring structure formation percentage) are shown in Table 1 and Table 2.

### Comparative Example 3

Into a reactor equipped with a reflux condenser, a dropping funnel, and an agitator were charged 100 parts of vinyl acetate, 26 parts of methanol, and as the unsaturated monomer (A), 0.1 parts of monomethyl maleate, and the temperature was elevated to 60° C. while stirring the mixture under a nitrogen stream. Then, as a polymerization catalyst, 0.001 mol % t-butylperoxyneodecanoate (with respect to the total amount of vinyl acetate) was charged to initiate polymerization. Immediately after initiating the polymerization, 2.2 parts of monomethyl maleate and 0.008 mol % t-butylperoxyneodecanoate (with respect to the total amount of vinyl acetate) were successively added in accordance with a polymerization rate. At a time point when the conversion (rate of polymerization) of vinyl acetate became 73%, the polymerization was terminated by adding: 0.01 parts of 4-methoxyphenol; and 58 parts of methanol for dilution and cooling.

Subsequently, unreacted vinyl acetate monomer was eliminated outside the system by a procedure of blowing a methanol vapor thereinto, whereby a methanol solution of a vinyl acetate copolymer was obtained.

Next, the solution was diluted with methanol so as to adjust the concentration to be 40%, and mixed with a 4% methanol solution of sodium hydroxide in a proportion (molar ratio of sodium hydroxide: 0.03) to provide 30 millimole with respect to one mole of the vinyl acetate structural unit in the vinyl acetate copolymer. The saponification reaction was conducted at a temperature setting of 40 to 50° C. A resin hardened by the saponification reaction was cut and dried at 70° C. to give a solid.

A 10% aqueous solution of the solid obtained as described above was produced, and a pH was adjusted to 2.6 by adding acetic acid, whereby a pH-adjusted aqueous solution was obtained.

The aqueous solution was dried, and subjected to grinding with a grinding machine so as to enable passing through a 42 mesh sieve in accordance with JIS, whereby a vinyl alcohol copolymer (PVA-9) was obtained. With respect to PVA-9 thus obtained, the components used for the polymerization, the conversion (rate of polymerization), the saponification condition, the concentration of acetic acid in the methanol solution for the washing operation, the average degree of polymerization, the degree of saponification, the viscosity of a 4% aqueous solution at 20° C., the content (modification amount) of the constituent unit derived from the unsaturated monomer (A), and the proportion of forming of a lactone ring structure by the constituent unit derived from the unsaturated monomer (A) (ring structure formation percentage) are shown in Table 1 and Table 2.

TABLE 1

| | | Components used for polymerization | | | | | Conversion |
|---|---|---|---|---|---|---|---|
| | | vinyl acetate | methanol | AIBN | unsaturated monomer (A) | | (rate of |
| | PVA | (parts | (parts | (parts | | (parts | polymerization) |
| | type | by mass) | by mass) | by mass) | (type) | by mass) | (%) |
| Example 1 | PVA-1 | 1,392 | 208 | 0.5 | methyl acrylate | 0.97 | 30 |
| Example 2 | PVA-2 | 1,392 | 208 | 0.5 | methyl acrylate | 1.16 | 30 |
| Example 3 | PVA-3 | 1,392 | 300 | 0.5 | methyl acrylate | 0.89 | 35 |
| Example 4 | PVA-4 | 1,392 | 310 | 0.8 | methyl methacrylate | 1.02 | 35 |
| Example 5 | PVA-5 | 1,392 | 300 | 0.5 | methyl acrylate | 1.16 | 35 |
| Example 6 | PVA-6 | 1,392 | 1,200 | 1.0 | methyl methacrylate | 1.02 | 40 |
| Comparative | PVA-7 | 72 | 8 | 0.008 | methyl acrylate | 0.118 | 37 |
| Example 1 | | | | | | | |
| Comparative | PVA-8 | 1,392 | 208 | 0.2 | itaconic acid | 1.23 | 30 |
| Example 2 | | | | | | | |
| Comparative | PVA-9 | 100 | 26 | 0.003** | monomethyl maleate | 2.2 | 73 |
| Example 3 | | | | | | | |

AIBN: 2,2′-azobisisobutyronitrile
Conversion (rate of polymerization): conversion (rate of polymerization) of vinyl acetate used
**amount of t-butylperoxyneodecanoate added

TABLE 2

| | | Saponification | | | | Washing | | | | | |
|---|---|---|---|---|---|---|---|---|---|---|---|
| | | | | concen- | | concen- | Physical properties of vinyl alcohol copolymer | | | | |
| | | | | tration of | | tration | | | viscosity | | |
| | | | | sapon- | | of acetic | average | | of 4% | | |
| | | | NaOH | ification | additional | acid in | degree | degree | aqueous | modifi- | percentage of |
| | | | molar | ingredient | NaOH molar | methanol | of poly- | of sapon- | solution | cation | forming ring |
| | PVA | Process | ratio | liquid | ratio | solution | merization | ification | at 20° C. | amount | structure |
| | type | (—) | (—) | (%) | (—) | (%) | (—) | (mol %) | mPa · s | (mol %) | (mol %) |
| Example 1 | PVA-1 | Gel | 0.04 | 20 | 0.02 | 0.01 | 3,830 | >99.9 | 95 | 2.24 | 82 |
| Example 2 | PVA-2 | Gel | 0.04 | 20 | 0.02 | 0.01 | 3,900 | >99.9 | 98 | 2.60 | 84 |
| Example 3 | PVA-3 | Slurry | 0.008* | 33 | — | 0.01 | 2,940 | >99.9 | 50 | 2.00 | 82 |
| Example 4 | PVA-4 | Gel | 0.04 | 20 | 0.02 | 0.1 | 2,850 | >99.9 | 49 | 2.00 | 96 |
| Example 5 | PVA-5 | Gel | 0.04 | 20 | — | 0.1 | 2,320 | 95.2 | 50 | 2.60 | 95 |
| Example 6 | PVA-6 | Gel | 0.04 | 20 | 0.02 | 0.1 | 1,560 | >99.9 | 18 | 2.00 | 97 |
| Comparative | PVA-7 | Gel | 0.03 | 15 | 0.03 | 0.04 | 4,330 | >99.9 | 88 | 5.03 | 90 |
| Example 1 | | | | | | | | | | | |
| Comparative | PVA-8 | Gel | 0.04 | 20 | 0.02 | 0.001 | 3,200 | >99.9 | 99 | 2.50 | <5 |
| Example 2 | | | | | | | | | | | |
| Comparative | PVA-9 | gel | 0.03 | 40 | — | — | 1,700 | 94 | 30 | 2.00 | 55 |
| Example 3 | | | | | | | | | | | |

NaOH molar ratio: molar ratio of sodium hydroxide to vinyl acetate unit in polyvinyl acetate
*molar ratio of sodium methylate

Each of vinyl alcohol copolymers obtained in Examples 1 to 6, and Comparative Examples 1 to 3 was evaluated on solubility and the amount of dehydration by the following methods. The results are shown in Table 3.

Evaluation on Solubility

Into a 140 mL beaker was placed 99 g of ion exchanged water, and 1 g of the vinyl alcohol copolymer was added thereto while stirring with a magnetic stirrer, and the mixture was stirred at room temperature for 2 hrs. The matter inside the beaker was filtrated through a filter paper, and the concentration (percentage of the solid content; %) of the filtrate was measured by a common procedure to determine the solubility (%) according to the following formula. It is to be noted that the solubility is 100% when 1 g of the vinyl alcohol copolymer has been entirely dissolved, and that lower solubility leads to superior water resistance during storage and operation.

Solubility (%)=(Concentration of the filtrate)×100

Production of Cement Slurry

A cement slurry was prepared by charging 3.31 g of the vinyl alcohol copolymer powder into a juice mixer, together with 327.75 g of ion exchanged water, 828.26 g of a class H cement for wells, 2.07 g of polycarboxylate ether (“Liquiment 1641F”, available from BASF), 1.73 g of a retardant (“D801”, available from Schlumberger Ltd.), and 1.46 g of a defoaming agent (“D206”, available from Schlumberger Ltd.), followed by mixing with stirring.

Amount of Dehydration

With respect to a resultant cement slurry, the amount of dehydration (mL) was determined according to a method described in “API (American Petroleum Institute) RP 10B-2”, in terms of an amount of dehydration which occurs in 30 min when the cement slurry, having been adjusted to 140 degrees Fahrenheit, is subjected to a condition involving 1,000 psi of differential pressure. It is to be noted that in a case in which water to be dehydrated is lost in less than 30 min, the amount of dehydration is calculated by using a time period until the water is lost. A smaller amount of dehydration indicates a superior anti-dehydrating effect.

### Comparative Example 4

With respect to Poval 49-88S2 manufactured by Kuraray Co., Ltd. (a vinyl alcohol polymer not including the constituent unit derived from the unsaturated monomer (A)), the solubility and the amount of dehydration were determined according to the method described above. The results are shown in Table 3.

TABLE 3

| | | | Amount of |
|---|---|---|---|
| | Vinyl alcohol | Solubility | dehydration |
| | copolymer | % | mL |
| Example 1 | PVA-1 | 26.0 | 28 |
| Example 2 | PVA-2 | 25.6 | 82 |
| Example 3 | PVA-3 | 25.1 | 27 |
| Example 4 | PVA-4 | 1.2 | 30 |
| Example 5 | PVA-5 | 52.6 | 130 |
| Example 6 | PVA-6 | 6.8 | 185 |
| Comparative | PVA-7 | 87.2 | 366 |
| Example 1 | | | |
| Comparative | PVA-8 | 99.2 | 383 |
| Example 2 | | | |
| Comparative | PVA-9 | 90.5 | 218 |
| Example 3 | | | |
| Comparative | 49-88S2 | 96.3 | 28 |
| Example 4 | | | |

Solubility: (concentration of a mixture prepared by adding 1 g of PVOH sample to 99 g of pure water after stirring at room temperature for 2 hrs) × 100
Amount of dehydration: determined according to API RP 10B-2, Clause 5 at differential pressure of 1,000 psi

As is clear from the results shown in Table 3, each of the vinyl alcohol copolymers of Examples 1 to 6 had low solubility, and was superior in water resistance during storage and operation. Also, the cement slurry to which each of these vinyl alcohol copolymers had been added, exhibited a small amount of dehydration at 140 degrees Fahrenheit, indicating a superior anti-dehydrating effect.

The vinyl alcohol copolymer of Comparative Example 1, in which a large amount of the unsaturated monomer (A) had been introduced, had high solubility and exhibited a large amount of dehydration, and was consequently inferior in water resistance during storage and operation, as well as in the anti-dehydrating effect.

The vinyl alcohol copolymer of Comparative Example 2, in which the proportion of forming of a lactone ring structure by the constituent unit derived from the unsaturated monomer (A) was low, had high solubility and exhibited a large amount of dehydration, and was consequently inferior in water resistance during storage and operation, as well as in the anti-dehydrating effect.

The vinyl alcohol copolymer of Comparative Example 3, in which the proportion of forming of a lactone ring structure by the constituent unit derived from the unsaturated monomer (A) was low, had high solubility and exhibited a large amount of dehydration, and was consequently inferior in water resistance during storage and operation, as well as in the anti-dehydrating effect.

The vinyl alcohol polymer of Comparative Example 4, which did not include the constituent unit derived from the unsaturated monomer (A), had high solubility, and was consequently inferior in water resistance during storage and operation.

1. A vinyl alcohol copolymer, wherein
the vinyl alcohol copolymer comprises a vinyl alcohol unit and a constituent unit derived from an unsaturated monomer (A),
the unsaturated monomer (A) is at least one selected from the group consisting of an unsaturated carboxylic acid, a salt thereof, an anhydride thereof, and an alkyl ester thereof,
a content of the constituent unit derived from the unsaturated monomer (A) with respect to total constituent units of the vinyl alcohol copolymer is 1.00 mol % or more and 5.00 mol % or less, and
70 mol % or more of the constituent unit derived from the unsaturated monomer (A) forms a lactone ring structure.

2. The vinyl alcohol copolymer according to claim 1, wherein the unsaturated monomer (A) is at least one selected from the group consisting of methyl acrylate and methyl methacrylate.

3. The vinyl alcohol copolymer according to claim 1, wherein a degree of saponification of the vinyl alcohol copolymer is 95 mol % or more.

4. The vinyl alcohol copolymer according to claim 1, wherein an average degree of polymerization of the vinyl alcohol copolymer is 1,500 or more and 5,000 or less.

5. The vinyl alcohol copolymer according to claim 1, wherein the vinyl alcohol copolymer is a powder capable of passing through a 7.5 mesh sieve in accordance with JIS.

6. A production method for producing the vinyl alcohol copolymer according to claim 1, comprising:
copolymerizing a vinyl ester monomer and the unsaturated monomer (A) to obtain a vinyl ester copolymer;
saponifying the vinyl ester copolymer to obtain a vinyl alcohol copolymer; and
washing with a solution of a carboxylic acid in alcohol, the vinyl alcohol copolymer after the saponifying.

7. A production method for producing the vinyl alcohol copolymer according to claim 1, comprising:
copolymerizing a vinyl ester monomer and the unsaturated monomer (A) to obtain a vinyl ester copolymer; and
saponifying the vinyl ester copolymer in a slurry state to obtain a vinyl alcohol copolymer.

8. An anti-dehydrating agent for a cement slurry, the anti-dehydrating agent comprising the vinyl alcohol copolymer according to claim 1.

9. An anti-dehydrating method for a cement slurry, the anti-dehydrating method comprising mixing a cement, a liquid formulation, and the anti-dehydrating agent for a cement slurry according to claim 8.
